(19) United States
(12) Patent Application Publication
(10) Pub. No.: US 2008/0204277 A1
(43) Pub. Date: Aug. 28, 2008

(54) Adaptive traffic signal phase change system

(76) Inventor: Roy Sumner, Great Falls, VA (US)

Correspondence Address: Daniel R. Gropper, PC, 9908 Dale Ridge Ct., Vienna, VA, 22181, US

(21) Appl. No.: 12/072,236

(22) Filed: Feb. 25, 2008

Related U.S. Application Data
(60) Provisional application No. 60/903,686, filed on Feb. 27, 2007.

(51) Int. Cl. G08G 1/07

(52) U.S. Cl. 340/910

(57) ABSTRACT

This patent provides a process that utilizes the vehicle to infrastructure communication process to gather anonymous vehicle trajectories that describe vehicles approaching a signalized intersection. This information is used to project forward in-time the positions of vehicles to calculate the optimal time to change the traffic signal at a point that will minimize the delay to the traffic.

### CROSS REFERENCE TO RELATED APPLICATIONS

This is a continuation-in-part of U.S. Provisional patent application Ser. No. 60/903,686 filed on Feb. 27, 2007.

### BACKGROUND OF THE INVENTION

1. Field of the Invention

The present invention relates to a process which utilizes an infrastructure communication process to gather information on vehicle trajectories approaching a signalized street intersection, and then calculates, from this information, the optimal signal time change to minimize traffic delay and maximize traffic flow.

2. Description of Related Art

Various adaptive control systems to control vehicle traffic flow employing various algorithms have been used to attempt to optimize traffic flow in conjunction with different ways of acquiring data on vehicle movement. U.S. Pat. No. 5,357,436 describes the use of measuring the saturation of traffic at an intersection based on vehicle count to control traffic signals so as to optimize traffic flow, while U.S. Pat. No. 5,668,717 shows varying the timing of traffic signals according to known peak periods of traffic.

U.S. Pat. No. 5,257,194 discloses setting up detectors at selected intersections. The information regarding traffic flow is feed from detectors to an array of local controllers which compare the various traffic parameters with the time of day and sends data to a local master controller which samples the data and determines traffic control signal cycle length. The data from the local master controller goes to a central controller which analyzes the data and cyclically directs the local master controllers to vary the traffic signal timing.

Other methods of controlling traffic movement sample the number of vehicles, via both pressure and Doppler sensors, to determine whether there is congestion as is taught by U.S. Pat. No. 4,370,718. Other patents determine the number of vehicles at a location over a time period to acquire traffic density as is taught by U.S. Pat. No. 3,414,876; or data gathered via discrete detection zones in determining saturation flow rates as described in U.S. Pat. No. 6,587,778.

These current adaptive control systems make use of single point upstream detectors, such as loops, to provide data about traffic approaching the intersection. The data from these point detectors is then used to generate information about incoming patterns of traffic, both in terms of their number and their timing. Current algorithms make pre-conceived assumptions about traffic speeds and sampling or traffic pattern dispersion. They then predict when each segment of the traffic will reach an intersection. A mathematical routine is then used to develop the optimal time to change the signal.

These approaches to adaptive control suffer from a series of problems. Often current systems are not aware of traffic that is held in a queue and fails to clear on a given green period. If a queue fails to clear before the end of the green period, and the system is unaware of this parameter, the system will assume that traffic is flowing smoothly, where it is actually failed in moving a queue through an intersection in an effective manner. All further system calculations and assumptions will be based on this erroneous data until the traffic deceases to a point in which the traffic does clear on a green signal, at which time the pre-conceived assumptions will again be valid.

Assumptions made about the traffic speed that may be correct at the location of the traffic detectors but this data may not be valid at locations apart from the detectors. This is due to any one or more of the factors of adverse traffic conditions, friction caused by adjacent traffic activity, and/or weather or other road conditions.

Assumptions from detector calculations that assume that all vehicles are the same length do not take into account the actual variations in vehicle size, length and speed. For example, erroneous data may be generated when tractor trailers are tabulated as passenger cars.

Finally, there is significant cost associated with the installation and maintenance of the detectors. Loop detectors break in hot regions due to road distortion and in cold regions due to frost damage. Video detectors are expensive to install and suffer from a range of problems such as occlusion, shadows and lack of effectiveness in the dark. The proposed process removes the requirement for these expensive and maintenance intensive vehicle detectors.

Another approach, as described in U.S. Pat. No. 6,169,495, is the use of a vehicle communication system which collects position, speed, and destination of various vehicles to make a determination of which course a vehicle may take in order to reduce the time of reaching a destination by having vehicles take non-overlapping paths. However, this method does not employ the use of changing traffic signal timing so as to reduce traffic congestion on a real-time basis and requires sophisticated and complex communication coordination between each vehicle and the traffic control system.

### SUMMARY OF THE INVENTION

The advent of multiple computers in modern vehicles has lead to an unprecedented capability to provide communication between roadside or infrastructure and the vehicle. One proposed implementation of this capability has been termed the Vehicle Infrastructure Integration (VII). VII is designed to provide safety, mobility and commercial applications within the vehicle by the use of applications in both the vehicle and in the infrastructure. These applications are supported by a communication system that enables two-way data transmission between vehicles and between vehicles and the infrastructure.

It is an object of the present invention to provide a unique method of using the proposed Vehicle Infrastructure Integration (VII) to optimally and dynamically determine how to maximize traffic signal and traffic throughput.

A further object of this invention is to provide an adaptive traffic signal control system using a phase change process which consists of a technique to determine when to change the traffic signal display using the trajectories of the approaching vehicles that are suitably equipped with wireless communication. This phase change process obtains position vectors of suitably equipped vehicles as they approach the intersection. These vectors are used to calculate vehicle trajectories which are used to determine the arrival time of each vehicle at the intersection. A delay minimizing algorithm is used at the intersection to calculate the optimal time to change the traffic signal display.

Using data from VII in an adaptive control system would overcome many of the problems of the related art as discussed above while permitting more extensive delay saving installations. This delay reduction over the current systems has been estimated between 18-20% at a single intersection and between 5-11% for systems.

Furthermore, the benefits of adaptive control can be realized without detectors. Thus, the removal of signal detectors would reduce maintenance costs while increasing traffic flow.

### BRIEF DESCRIPTION OF THE DRAWINGS

FIG. 1 illustrates the process flow block diagram of the instant invention.

FIG. 2 illustrates the hardware component block diagram of the instant invention depicting how an adaptive control processor connects to roadside equipment and a traffic signal controller.

FIG. 3 illustrates a timeline of the signal interface processing of the instant invention from the initialization process start up through interactive continuous looping.

FIG. 4 illustrates a map of typical road lane configuration as used in the instant invention.

FIG. 5 illustrates the steps taken by an adaptive signal processor of the instant invention.

FIG. 6 illustrates a sector diagram used for determining an approach heading of the instant invention.

FIG. 7 illustrates a map of snapshots made of vehicle paths in a typical road lane configuration of the instant invention.

### DETAILED DESCRIPTION OF THE INVENTION

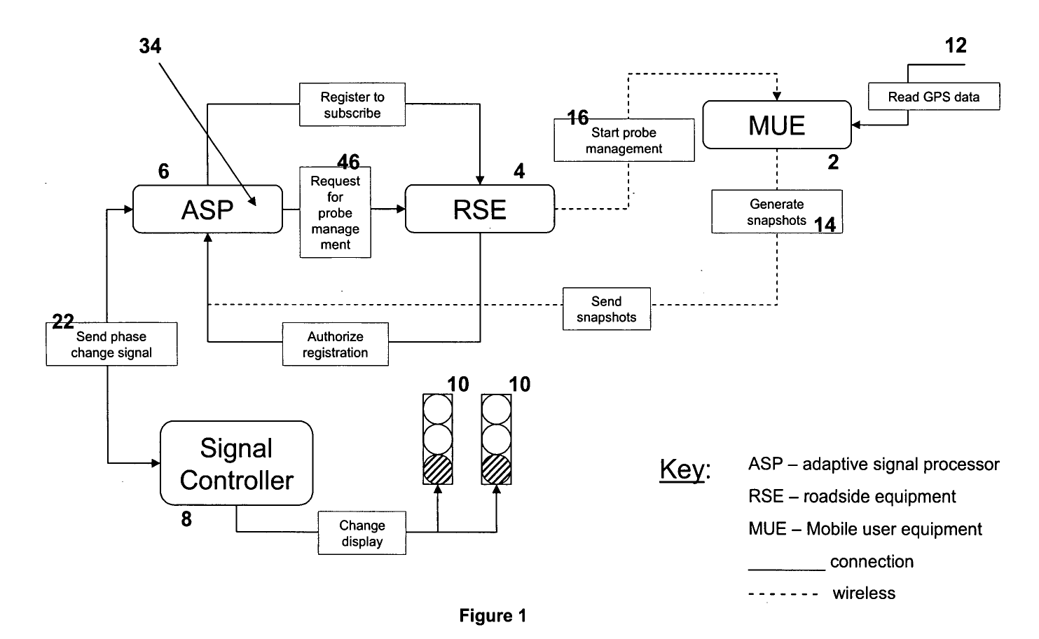

The adaptive control process of the instant invention consists of series of elements as shown in FIG. 1. They comprise mobile user equipment (MUE) 2 which is intermittently in wireless communication with roadside equipment (RSE) 4. An adaptive control signal processor (ASP) 6 communicates with RSE 4 to inform a signal controller 8 of the optimal time to make phase changes to traffic signals 10, 10′. These elements are structured such that they can be developed as separate software and/or software/hardware modules.

The flow of events is as follows:

1. Probe Management to Roadside Equipment

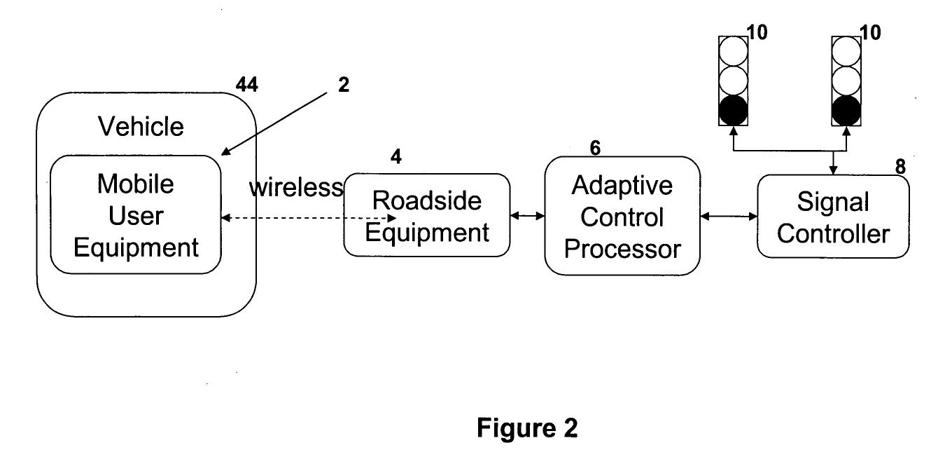

Referring to FIG. 2, MUE 2 reads real time GPS data 12 through known means to create a series of data snapshots 14 of a vehicle 44 position and movement with respect to a traffic signals 10, 10′. Traditionally, when vehicle 44 is within range of a RSE 4, a single data message containing multiple snapshots 14 is transmitted from vehicle 44 to RSE 4 and no further interaction takes place. This single data snapshot 14 does not provide enough information to take advantage of the traffic management activities of the ASP 6. A trajectory 18, 18′ of vehicle 44, as it approaches and passes through a signal 10, 10′, of a controlled intersection 52 is also needed.

To obtain this additional required information RSE 4, upon receiving broadcast data snapshot 14 from MUE 2, will broadcast a message to all such vehicles 44 to alter the rate at which data snapshots 14 are collected and broadcast. Essentially, the first vehicle 44 to interact with RSE 4 causes RSE 4 to send out a request for trajectory information from all vehicles 44 in the range of the instant invention to obtain as many data points as possible on which to process with ASP 6.

To begin this enhanced data acquisition sequence, RSE 4 will begin its probe message sequence 16 as follows:

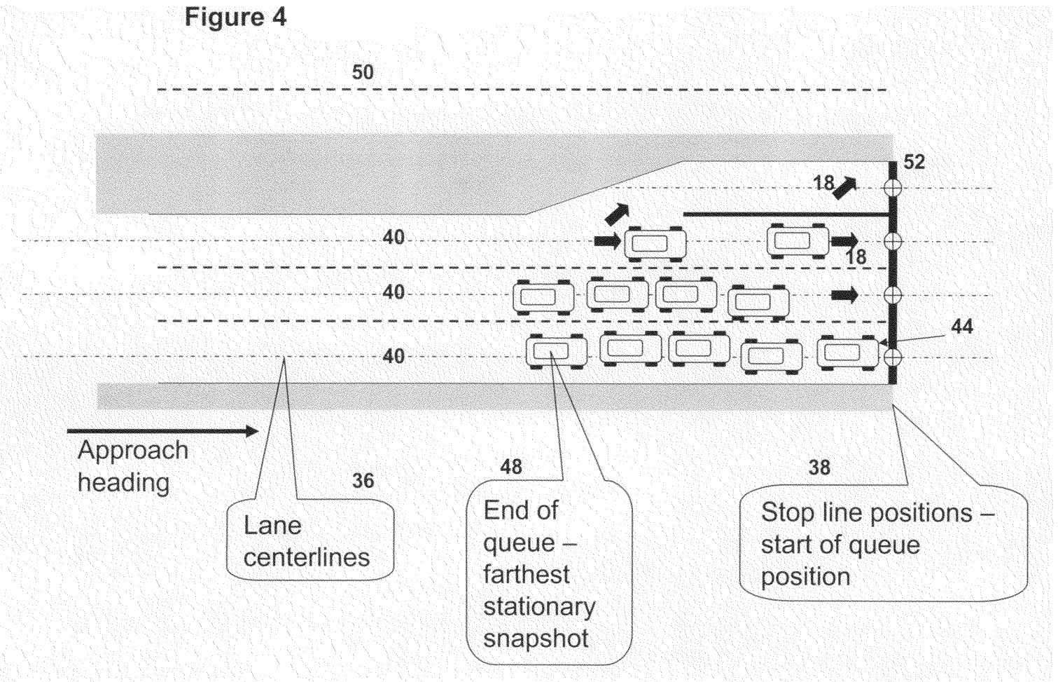

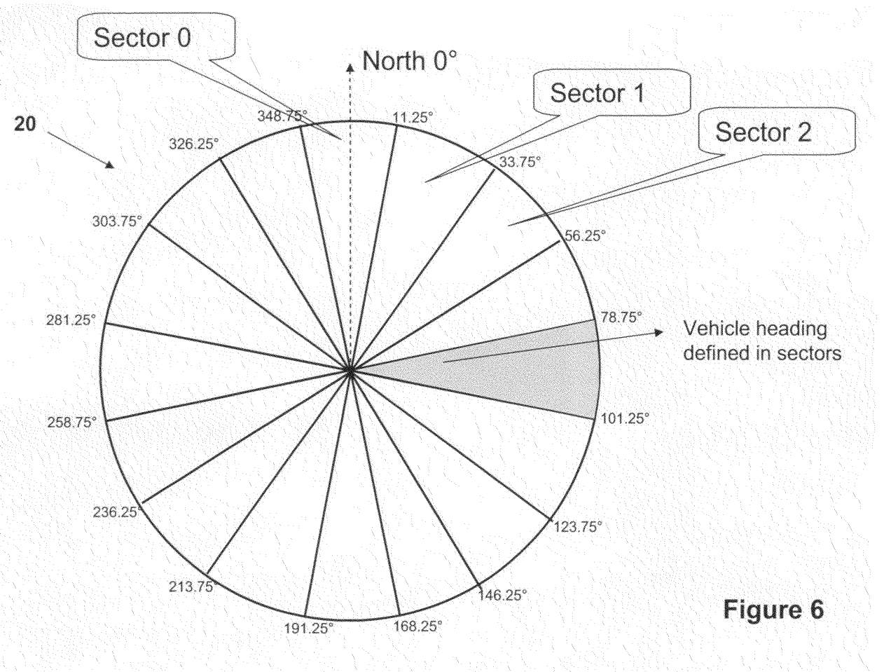

An operator of a traffic signal 10, 10′ system will predefine the approach headings 18, 18′ from position and movement of the vehicles 44 during intersection 52 approaches that are of concern to traffic signals 10, 10′. These approach headings 18, 18′, as shown in FIG. 4, and are designated within probe message 16 in coded sectors 20, as shown in FIG. 6. For example, each sector 20 would have an arc of 22.5 degrees in length and be numbered as 0 through 15. As shown in FIG. 6, sector 0 would be centered on North or zero degrees and varying between 348.75 and 11.25 degrees. Sector 1 would be centered on 22.5 degrees and varying between 11.25 and 33.75. This pattern would be repeated for the remaining sectors 2 through 15. The operator can designate which vehicle 44 approach the traffic signals 10, 10′ from which to collect data snapshots 14. Probe message 16 will also define the rate at which data snapshots 14 are taken of the vehicle 44 (e.g. 2 seconds) and the rate at which probe messages 16 are sent to RSE 4. A normal default probe message cycle is 2 seconds. Probe message 16 should be flagged to stop transmission when vehicle 44 is out of range of the broadcasting RSE 4.

ASP 6 is provided which creates a communication session with RSE 4 to create a signal controller message 22. Signal controller message 22 from ASP 6 to signal controller 8 informs signal controller 8 of the optimal time to make the next phase change in traffic signals 10, 10′. Signal controller 8 provides ASP 6 with its timing data concerning the movement of vehicles within their respective sector 20.

2. Subscribe to Local Probe Data

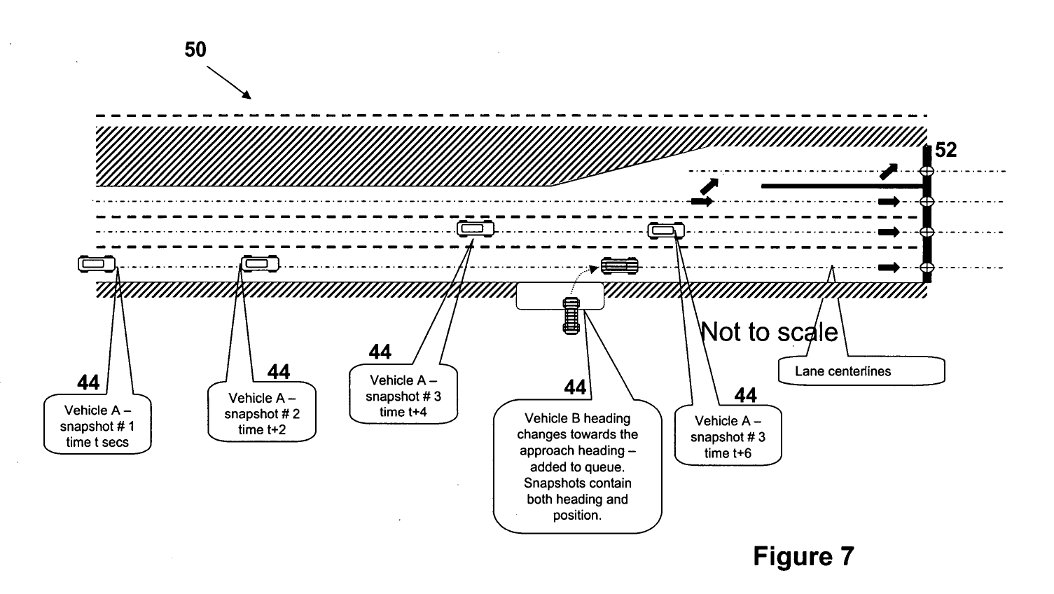

ASP 6, having sent probe request message 16 to RSE 4, will then subscribe to acquire snapshot data 14 from RSE 4. Snapshot data 14 contains multiple snapshots including approach headings 18, 18′ of vehicles 44. As shown in FIG. 4, probe request messages 16 would include the position, heading and speed of each vehicle 44, in addition to a Probe Segment Number (PSN) 24 that is designed specifically to track an individual vehicle 44. PSN 24 is an anonymous identifier that indicates that a series of data snapshots 14 all originated from the same vehicle 44 over time as shown in FIG. 7. Also shown is second vehicle 44′ which is added to the probe message 16 in the course of taking snapshots. Since anonymity must be maintained, the PSN 24 allows vehicle 44 approach headings 18 to be derived anonymously. As data snapshots 14 are received, new PSN 24 data is added to memory 34 in the ASP 6. Existing PSN 24 numbers will have their locations updated with each newly received data snapshot 14. Each intersection 52 will have a local map 50 comprising the lane centerlines 36 and stop line positions 38 of each approach to the intersection 52 52, as depicted by FIG. 4. This map 50 only exists in the ASP 6, and is not required in the vehicle 44 for this invention to operate. Map 50 shown is merely geometric data and requires no navigation system in vehicle 44. Map 50 contains the lane centerlines 36 on each approach coded in terms of latitude and longitude derived from GPS data 12. Map 50 will be retrieved from the RSE 4 and used with probe request messages 16 to allocate vehicles 44 to individual lane centerlines 36 and hence their appropriate traffic signal 10, 10′ phase.

GPS data 12 and the position where the lane centerlines 36 cross the stop line positions 38 are needed to determine the lane 40, 40′, 40″ in which the vehicle 44 is disposed. GPS data 12 gathered by the MUE 2, including data snapshot 14, is sent to RSE 4 and hence to ASP 6. Stop line position 38 is used to determine a start of a queue position. GPS data 12 from each lane 40, 40′, 40″ together with start and stop positions of vehicles 44 are used to assist in queue length and delay determination. GPS data 12 from center line 40′ can be automatically generated by leaving the ASP 6 in a calibration mode whereby it gathers positional GPS data 12 and aggregates GPS data 12 to determine an average vehicle approach heading 18 for each lane 40, 40′, 40″.

GPS data 12, as subscribed to by ASP 6, includes lane centerlines 36, lane stop positions 38 and lanes 40, 40′, and 40″, when a vehicle 44 stops. When a specific vehicle 44, designated by its PSN 24, makes one or more stops that will impede any particular flow movement, the calculated saturation flow rate, which is the number of vehicles 44 moving during a green period, will be adjusted accordingly, as described later in detail.

3. Develop Queue Estimates

In order to estimate a queue length 54 by lane 40, 40′, 40″ on each approach heading 18, the lane stop positions 38 together with GPS dynamic data 12 will be used to determine queue length 54. Queue length 54 is determined by keeping track of a position 48 of the furthest stopped or stationary vehicle 44 taken during a data snapshot 14. This approach allows for traffic signal 10, 10′ optimization under congested as well as normal operating conditions. Under normal conditions, the last stopped vehicle 44 will start and not stop again before it has passed the stop line. Under congested conditions, the last stopped vehicle 44 will start and then stop again before the stop line while within range of the RSE 4. Then a new furthest stopped vehicle 44 will be detected as the queue length 54 increases. The lane 40 information will be stored according to the appropriate phase 22 of traffic signal 10. For example, if there are two through lanes 40 and 40′ on one phase of traffic signal 10 and one left turn on a second phase, these queues and the later flow data will be calculated separately for each traffic signal phase 22. Thus, for each separate movement of traffic, a separate lane queue 54 will be maintained. A traffic movement consists of one or more lanes 40, 40′, 40″ that see the same traffic signal 10, 10′ indications at the same time.

Mid-block 56 sources and sinks consist of vehicles 44 that either join or leave the traffic flow between intersections mid block 56. Examples of this will be vehicles 44 which accessing a local driveway or a gas station as are shown in FIG. 7. These vehicles 44 will be accommodated as follows. Vehicles 44 that make a heading 28 change towards a particular approach heading 18 will be considered source vehicles and added to the queue, and vehicles 44 that make a heading 18 change away from the particular approach direction will be considered sink vehicles and removed from the queue. An example of such is shown by vehicle 44′ in FIG. 7. Since the approach heading 18 information from each path is included in vehicle 44 data snapshots 14, these movements to and away from the approach heading 18 to and from traffic signal 10 10′ can be identified.

Vehicles 44 leaving an intersection 52 will continue reporting to the ASP 7 until they are out of range as determined by the lack of a radio signal or by the GPS position having passed the stop line position 38 of an intersection 52 52. Vehicles 44 will be removed from the queues as they pass the stop line 38 as indicated by the snapshot data 14.

Initially, the market penetration of VII equipped vehicles will be low. Assumptions will be made by using the stationery vehicle 44 locations to estimate in real-time the current market penetration and add sufficient unequipped vehicles to fill in the gaps. The stationary location of VII equipped vehicles 44 will be known from the snapshot data 14. Using these positions, estimations will be made of the unequipped vehicle 44 count by noting gaps between equipped vehicles 44 and inferring a total vehicle count. As the number of equipped vehicles 44 grows, the estimates will become more accurate.

4. Determine Traffic Algorithm

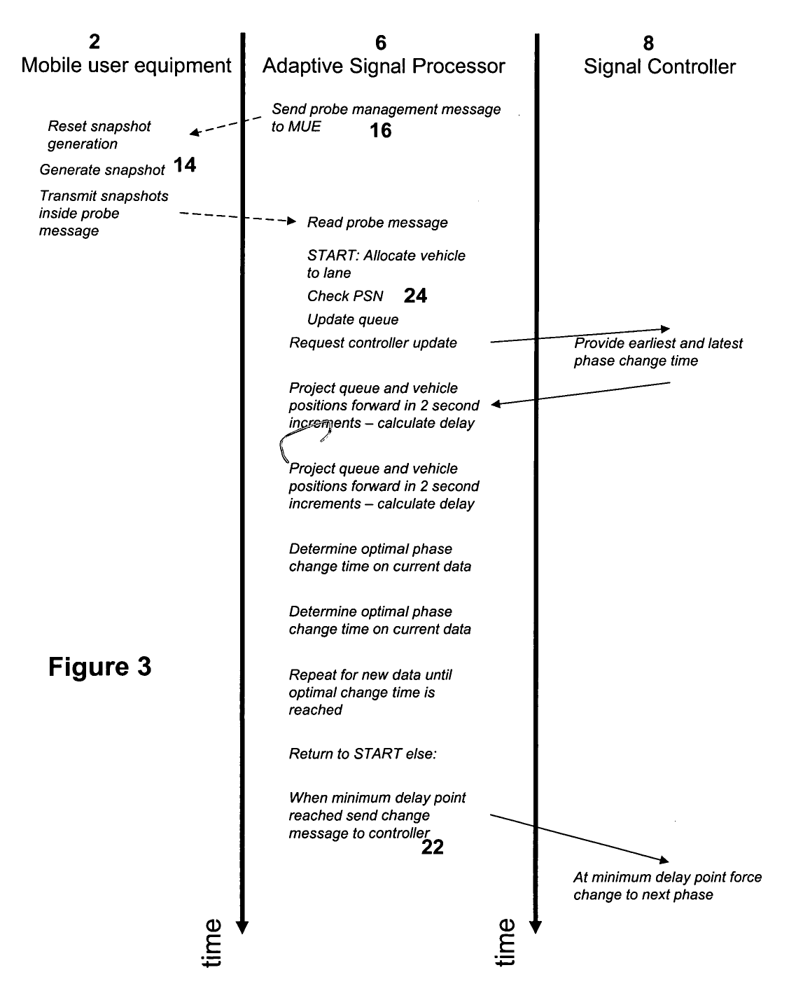

The objective function of this process is to minimize the delay at the individual intersections 52. This part of the process will be a microscopic approach that will project forward the current state of the traffic. The process selects the optimal time for the next phase change by minimizing the vehicle delay at all approach headings 18. Each lane can be considered separately with vehicles 44 in a queue. The length of a queue is determined from the snapshot data 14. Snapshots 14 are taken as vehicles 44 start and stop. Thus, at all times, the current length of the queue is known. During the green period, the queue discharges at the saturation flow rate. During the red period, the flow is zero. Mathematically, the approach headings 18, 18′ of each equipped vehicle 44 are known, and thus the time at which the vehicles 44 arrive at the rear end of the queue 48 can be predicted. Thus, the queue's length and the total delay time can be calculated for each two second interval into the future. Furthermore, the interval time of two seconds is a default wherein the interval time may be altered according to local site conditions. It is the total delay on all approaches that is used to calculate at what time an optimal change of the traffic phase 22 should occur. The optimal time change is calculated by looking at the cumulative delay for all approaches 18, 18′ into the future at two second intervals. The duration into the future is a variable set for each intersection 52 52, taken at a default time of two minutes. For each of these duration intervals, the delay is calculated as if the phase change 22 was made. At the point in time that the minimum total delay occurs, this is the point where the system makes the phase change 22. FIG. 3 describes in detail the algorithm taking place in and between MUE 2, ASP 6, and signal controller 8. After initial start up process, the illustrated processing loop can operate continuously.

This traffic projection made by ASP 6 will use both the current queue length and the vehicle vectors of position and speed as follows:

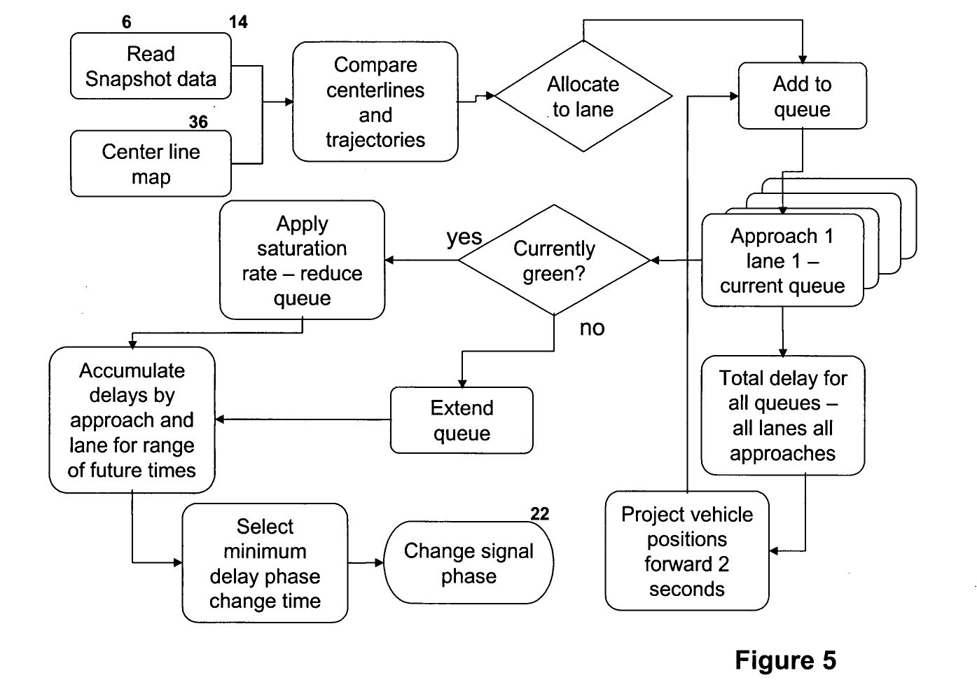

Step 1—As shown in FIG. 5, a model is formed of the traffic using GPS data 12 to develop a map of current vehicle vectors (i.e., position 26, speed 30, and time 42) and project forward in time and location 2 seconds so as to acquire a current phase data snapshot 14. Estimated projections will need to be made to take into account unequipped vehicles. Since VII equipped vehicles report stops and starts, by using the mean distance between simultaneously stopped vehicles 44, an assumption on mean vehicle length allowance can be made for those unequipped vehicles. Measuring this dynamically will allow for changes in market penetration as more vehicles 44 are so equipped both geographically and over time.

Step 2—For those queues with a current moving or green phase, reduce queue length using a saturation flow value as measured by the system. By following the phase change to green, the traffic flow at the stop line positions 38 will be measured by using the allowance for unequipped vehicles the flow of equipped vehicles to estimate the saturation flow used in the queue calculations made earlier.

Step 3—For those queues with a stopped or red phase, calculate a new queue length in accordance with probe management instruction which requires vehicles to report a position at a stop and at a start.

Step 4—Contact the signal controller 8 and determine when the next valid phase change should occur. Repeat the aforementioned steps for each two second increment, and accumulate forward in time a series of data snapshots 14, either to the end of the queue or through the intersection 52, to make an array of a total delay for each approach to be projected into the future for a minimum time until a next phase change is due. Calculate an optimal phase change by using the current queue length and vehicle vectors and estimate a delay for a series of future phase change opportunities so as to minimize traffic delays. Then apply the phase change traffic signal 10, 10′ to the signal controller 8 of appropriate approaches to change, record this change, and continue calculating the accumulated delay on each approach. Read the next change time and continue until the maximum time for the next phase change is reached.

Step 5—Optimize the next phase change time by selecting a valid interval that minimizes the total delay for the intersection 52.

Step 6—After the maximum time is reached from the previous phase change traffic signal 10, 10′ to the signal controller 8, return to step 1.

No attempt is made here to optimize an entire network. Optimizing the entire network, although desirable, can be performed by adjustments to multiple controllers and moving them towards a common cycle time and optimal offsets. However this process is best performed at the central location that can be used to coordinate all controllers.

The intent of this invention is to make use of existing controllers that are capable of providing the phase information required and that have firmware that allows the next phase to be called remotely. This process will occur using a new processor that communicates with RSE 4 and a suitable signal controller 8.

It is envisioned that ASP 6 is sited between the standard RSE 4 for VII and the signal controller 8. ASP 6 is independent from the signal controller and is designed to operate with multiple controller types. To aid understanding, ASP 6 is described here as a separate processor running an application. However, there is no reason why ASP 6 cannot be configured as a component of either the RSE 4 or signal controller 8. Also, MSE 2 can be made part of the vehicle 44 or as an aftermarket product such as a navigation system or a hand held device such as a cell phone.

It is to be understood that while certain forms of the present invention have been described herein, it is not to be limited to the specific forms or arrangement of method described and shown and herein and other forms of the invention can be practiced as taught herein without departing from the nature and spirit of the invention.

What I claim is:

1. An interactive vehicle traffic flow control system comprising:
a) At least one vehicle, said vehicle having a method of uniquely and remotely identifying said vehicle's real time identity and location;
b) At least one controllable traffic signal;
c) At least one roadside equipment to capture said vehicle's method of uniquely and remotely identifying said vehicle's real time identity and location, wherein said roadside equipment is in data communication with said vehicle;
d) At least one adaptive signal processor connected to said roadside equipment to process said vehicle's method of uniquely and remotely identifying said vehicle's real time identity and location, wherein said adaptive signal processor calculates the optimum signal phase change time for said controllable traffic signal based on the unique identity and location of said vehicle; and
e) At least one signal controller, connected to said adaptive signal processor, and connected to said traffic signal, wherein said signal controller responds to instructions from said adaptive signal processor and changes said phase timing in said traffic signal so as to minimize traffic delays.

2. An interactive vehicle traffic flow control system, as recited in claim 1, wherein said method of uniquely and remotely identifying said vehicle's real time identity and location utilizes vehicle infrastructure integration.

3. An interactive vehicle traffic flow control system, as recited in claim 1, wherein said method of uniquely and remotely identifying said vehicle's real time identity and location utilizes radio communication.

4. An interactive vehicle traffic flow control system, as recited in claim 1, wherein said method of uniquely and remotely identifying said vehicle's real time identity and location utilizes global positioning data.

5. An interactive vehicle traffic flow control system, as recited in claim 1, wherein said roadside equipment, upon initially detecting a said vehicle with the operating range of said roadside equipment, will request multiple updated bursts of data from said vehicle thereby providing said roadside equipment with a data stream from one said vehicle to create a data snapshot of said vehicle's position, speed and direction.

6. An interactive vehicle traffic flow control system, as recited in claim 1, wherein said roadside equipment, upon initially detecting a said vehicle with the operating range of said roadside equipment, will request multiple updated bursts of data from all said vehicles within the operating range of said roadside equipment thereby providing said roadside equipment with a data stream from all said vehicles in the operating range of said roadside equipment to create a data snapshot of each of said vehicle's position, speed and direction.

7. An interactive vehicle traffic flow control system, as recited in claim 5, wherein said vehicle's position, speed and direction is determined with respect to predefined sectors.

8. An interactive vehicle traffic flow control system, as recited in claim 7, wherein said vehicle's position, speed and direction is determined with respect to predefined sectors, wherein each predefined sector is approximately 20 degrees.

9. An interactive vehicle traffic flow control system, as recited in claim 1, wherein said multiple updated bursts of data from said vehicle are requested by said road side equipment in two second cycles.

10. An interactive vehicle traffic flow control system, as recited in claim 1, wherein said vehicle's real time identity and location is anonymous.

11. An interactive vehicle traffic flow control system, as recited in claim 1, wherein said vehicle's real time identity and location is calculated into a queue by said adaptive signal processor.

12. An interactive vehicle traffic flow control system, as recited in claim 1, wherein each of said vehicle's real time identity and location within the operating range of said roadside equipment is calculated into a queue by said adaptive signal processor.

13. An interactive vehicle traffic flow control system, as recited in claim 11, wherein said vehicle's real time identity and location is calculated into a queue by said adaptive signal processor, wherein a said vehicle that enters mid block will be added to the queue.

14. An interactive vehicle traffic flow control system, as recited in claim 11, wherein said vehicle's real time identity and location is calculated into a queue by said adaptive signal processor, wherein a said vehicle that exits mid block will be deleted from the queue.

15. An interactive vehicle traffic flow control system, as recited in claim 11, wherein said adaptive signal processor adds an estimation to said queue to account for said vehicles without said vehicle's method of uniquely and remotely identifying means.

16. An interactive vehicle traffic flow control system, as recited in claim 11, wherein each said vehicle is removed from said queue when said vehicle has exited said are of control of said roadside equipment.

17. An interactive vehicle traffic flow control system, as recited in claim 11, wherein the phase of each of said traffic signals is adjusted for minimum queue delay by said adaptive signal processor.

18. An interactive vehicle traffic flow control system comprising the steps of:
a) Detecting at least one vehicle, said vehicle having a method of uniquely and remotely identifying said vehicle's real time identity and location;
b) Having at least one controllable traffic signal;
c) Using at least one roadside equipment to capture said vehicle's method of uniquely and remotely identifying said vehicle's real time identity and location, wherein said roadside equipment is in data communication with said vehicle;
d) Using at least one adaptive signal processor connected to said roadside equipment to process said vehicle's method of uniquely and remotely identifying said vehicle's real time identity and location, wherein said adaptive signal processor calculates the optimum signal phase change time for said controllable traffic signal based on the unique identity and location of said vehicle; and
e) Using at least one signal controller, connected to said adaptive signal processor, and connected to said traffic signal, wherein said signal controller responds to instructions from said adaptive signal processor and changes said phase timing in said traffic signal so as to minimize traffic delays.

19. An interactive vehicle traffic flow control system, as recited in claim 17, further comprising the step of uniquely and remotely identifying said vehicle's real time identity and location utilizes vehicle infrastructure integration.

20. An interactive vehicle traffic flow control system, as recited in claim 17, further comprising the step of detecting a said vehicle with the operating range of said roadside equipment, will request multiple updated bursts of data from all said vehicles within the operating range of said roadside equipment thereby providing said roadside equipment with a data stream from all said vehicles in the operating range of said roadside equipment to create a data snapshot of each of said vehicle's position, speed and direction.
